(19) United States
(12) Patent Application Publication
(10) Pub. No.: US 2026/0209651 A1
(43) Pub. Date: Jul. 23, 2026

(54) DETERGENT COMPOSITIONS

(71) Applicant: INNOSPEC LIMITED, Ellesmere Port Cheshire (GB)

(72) Inventors: Alessandra ANDREOLI, Castiglione delle Stiviere (IT); Maurizio PERONI, Castiglione delle Stiviere (IT)

(21) Appl. No.: 19/141,129

(22) PCT Filed: Dec. 22, 2023
(86) PCT No.: PCT/EP2023/087558

§ 371 Date: Jun. 19, 2025

(30) Foreign Application Priority Data
Dec. 22, 2022 (GB) 2219599.4

(51) Int. Cl. C11D 17/04; C11D 1/06; C11D 1/34; C11D 1/83; C11D 1/88; C11D 3/30; C11D 3/386; C11D 3/43; C11D 10/04

(52) U.S. Cl. CPC C11D 17/042; C11D 1/06; C11D 1/342; C11D 1/83; C11D 1/88; C11D 3/30; C11D 3/38618; C11D 3/38627; C11D 3/38636; C11D 3/43; C11D 10/04; C11D 2111/12

(57) ABSTRACT

A detergent composition comprising (a) at least one salt of an alkanolamine and an alkyl ether carboxylic acid; (b) at least one surfactant; and (c) at least one solvent including at least one hydroxy functional group. The detergent composition may be particularly useful as liquid detergent compositions for use in household cleaning applications, for example for use in laundry. A method of laundering items using the detergent composition and the use of a salt of an alkanolamine and an alkyl ether carboxylic acid to improve the cleaning performance of a detergent composition comprising at least one enzyme are also disclosed.

### FIELD

The present invention relates to detergent compositions. In particular the invention relates to liquid detergent compositions having improved properties for use in toilet care, manual dishwashing, laundry, fabric care, kitchen care, carpet cleaning, air fresheners, vehicle care, polishing products, machine cleaning and maintenance, pesticides, insecticides, fungicides, herbicides, oilfield chemical applications, marine applications, personal care and institutional/industrial cleaning. The detergent compositions may be especially useful in household cleaning applications, for example for use in laundry.

### BACKGROUND

Detergent compositions are commonly known for household use, particularly for laundry and dishwashing applications. Such compositions may be provided in loose powder or liquid form where a user measures out a dose each time before use.

Many consumers prefer to buy detergent compositions in unit dose form in which the dose is pre-measured and a single tablet or pouch is added to the washing machine or dishwasher. Unit dose detergent compositions are often provided in the form of compressed powder tablets or pouches comprising liquids encapsulated in a water-soluble polymer.

Environmental concerns are becoming increasingly important in relation to consumer products, with many consumers seeking to choose products which have a reduced environmental impact compared to well-established products. It is therefore highly desirable to provide detergent compositions for various uses which are produced from sustainable chemical feedstocks.

The sustainability of a product such as a detergent composition can be measured by the renewable carbon index (RCI). The RCI of a product can be calculated by dividing the number of carbons derived from renewable sources by the total number of carbons in an active ingredient. A high RCI value means that the product, a detergent active ingredient for example, contains a high percentage of carbon atoms from sustainable sources.

It is also possible for a laundry detergent composition to provide a reduced environmental impact by providing effective cleaning at low temperatures so that less energy needs to be used in a washing cycle.

Modern laundry detergents commonly comprise linear alkylbenzenesulfonate (LAS) active ingredients. LAS has been a preferred surfactant for such applications due to its good cleaning performance at low temperatures and relatively low cost. However, LASs are synthetic anionic surfactants which are produced from petrochemical feedstocks and are not currently obtainable from renewable sources. Therefore the use of LAS in detergent compositions may prevent a high RCI being obtained for the detergent composition. LAS also presents further environmental concerns due to potential toxicity to aquatic life. Furthermore, LAS surfactants may negatively affect the performance of certain enzymes in detergent compositions, for example by reacting with and breaking down the enzymes. Therefore alternative detergent compositions which do not comprise LAS may be desirable.

Also important in the manufacture of detergents is the safety of the components used, with skin and ocular irritancy minimised as far as possible.

It is an aim of the present invention to provide a novel detergent composition which overcomes at least one disadvantage of the prior art whether stated herein or otherwise.

### SUMMARY OF INVENTION

It is one aim of the present invention, amongst others, to provide a novel detergent composition and related methods and uses that addresses at least one disadvantage of the prior art, whether identified here or elsewhere, or to provide an alternative to existing detergent compositions. For instance, it may be an aim of the present invention to provide a detergent composition which is free from LAS and has a relatively high RCI, whilst providing good cleaning performance, particularly at low temperatures.

According to aspects of the present invention, there is provided a detergent composition, method and use as set forth in the appended claims. Other features of the invention will be apparent from the dependent claims, and from the description which follows.

According to a first aspect of the present invention, there is provided a detergent composition comprising:
(a) at least one salt of an alkanolamine and an alkyl ether carboxylic acid;
(b) at least one surfactant; and
(c) at least one solvent including at least one hydroxy functional group.

Component (a) is a surfactant formed from an alkanolamine and an alkyl ether carboxylic acid (ACE).

The alkyl ether carboxylic acid of component (a) suitably has the formula (I):

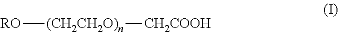

wherein R is a C8 to C24 optionally substituted alkyl or alkenyl group; and
n is an average value from 3 to 18.

The alkyl ether carboxylic acid referred to herein as present in the salt of component (a) is in its anionic form in the salt, i.e. with the carboxylic acid deprotonated. The alkyl ether carboxylic acid of component (a) may therefore be referred to as an alkyl ether carboxylate anion. Therefore the alkyl ether carboxylate of component (a) suitably has the formula (Ia):

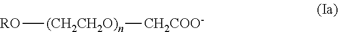

Suitably R is a C10 to C18 optionally substituted alkyl or alkenyl group, suitably a C12 to C16 optionally substituted alkyl or alkenyl group, preferably linear.

The R group is suitably an alkyl group, preferably a linear alkyl group.

The value n represents the average level of ethoxylation of the R group in formula (Ia) above. This may be considered an average ethoxylation of a fatty alcohol from which the alkyl ether carboxylate is derived. As n is an average value, component (a) may contain compounds which have more or fewer CH₂CH₂O groups than specified, provided that the average number of these groups present in the component (a) is within the stated range. Suitably and n is from 3 to 8, suitably from 4 to 6. For example, n may be approximately 5. In such an example, the alkyl ether carboxylic acid may be laureth-5 carboxylic acid.

The alkyl ether carboxylic acid of component (a) may be selected from any one or more of laureth-4 carboxylic acid, laureth-5 carboxylic acid, laureth-6 carboxylic acid, laureth-8 carboxylic acid, laureth-10 carboxylic acid, laureth-11 carboxylic acid, trideceth-7 carboxylic acid, trideceth-8 carboxylic acid, C11-15 pareth-7 carboxylic acid, C12-13 pareth-5 carboxylic acid, C12-15 pareth-5 carboxylic acid, C12-15 pareth-6 carboxylic acid, C14-15 pareth-8 carboxylic acid, deceth-7 carboxylic acid, myreth-5 carboxylic acid or capryleth-9 carboxylic acid.

The alkanolamine of component (a) may be selected from a monoalkanolamine, a dialkanolamine, a trialkanolamine, an N-alkyl alkanolamine or an N-hydroxyalkyl alkanolamine, or a mixture thereof. Suitable N-alkyl alkanolamines are methyl alkanolamines. Suitable N-hydroxyalkyl alkanolamines are N-hydroxymethyl alkanolamines.

The alkanolamine of component (a) is suitably a monoalkanolamine or a dialkanolamine. The alkanolamine of component (a) is suitably a monoalkanolamine or a dialkanolamine having 2 to 6 carbon atoms. Suitably the alkanolamine is selected from monoethanolamine, monopropanolamine, monoisopropanolamine, monobutanolamine and diethanolamine, or a mixture thereof.

Preferably the alkanolamine is a monoalkanolamine, suitably having from 2 to 4 carbons. In some embodiments, the alkanolamine is monoethanolamine (MEA).

The alkanolamine referred to herein as present in the salt of component (a) is in its cationic form, i.e. with the nitrogen protonated. The alkanolamine of component (a) may therefore be referred to as an alkanolammonium ion.

Suitably component (a) comprises at least one salt of a monoalkanolamine and an alkyl ether carboxylic acid of formula (I).

In some embodiments, component (a) comprises a salt of monoethanolamine and laureth-5 carboxylic acid.

Component (a) is suitably present in an amount of at least 10 wt %, at least 15 wt % or at least 20 wt % of the detergent composition.

Component (a) is suitably present in an amount of up to 50 wt %, up to 40 wt % or up to 30 wt % of the detergent composition.

Component (a) is suitably present in an amount of from 10 to 50 wt %, from 10 to 40 wt % or from 15 to 35 wt % of the detergent composition.

The inventors have found that the salts of an alkanolamine and an alkyl ether carboxylic acid as defined above can provide the main active ingredient of a detergent composition which shows high cleaning performance without the use of the LAS component, and allows a relatively high RCI value to be obtained for the detergent composition as a whole. The detergent composition may exhibit particularly good cleaning performance in laundry applications at relatively low temperatures.

Suitably the detergent composition comprises less than 10 wt %, less than 5 wt % or less than 1 wt % of alkylbenzenesulfonates (linear and branched). Specifically, the detergent composition preferably comprises less than 10 wt %, less than 5 wt % or less than 1 wt % of linear alkylbenzenesulfonates and preferably no branched alkylbenzenesulfonates. Preferably the detergent composition is substantially free of alkylbenzenesulfonates. Suitably the detergent composition comprises no linear alkylbenzenesulfonates and no branched alkylbenzenesulfonates.

As described above, component (a) is formed from an alkanolamine and an alkyl ether carboxylic acid (ACE). Component (a) may be formed before it is combined with the remaining components of the detergent composition, i.e. the detergent composition may be formed by admixing component (a) with components (b) and (c) and any other components of the detergent composition. In some embodiments, component (a) may be formed in situ in the detergent composition by admixing the alkanolamine and the alkyl ether carboxylic acid separately with the remaining components of the detergent composition. In such embodiments, the alkanolamine and the alkyl ether carboxylic acid react to form the salt of component (a).

The detergent composition of this first aspect comprises component (b) at least one surfactant. Component (b) is different to component (a). Therefore component (b) does not comprise a salt of an alkanolamine and an alkyl ether carboxylic acid. This at least one surfactant suitably comprises a non-ionic surfactant. Suitable non-ionic surfactants will be known to the person skilled in the art. Such non-ionic surfactants may increase the cleaning performance of the detergent composition, in particular on oil and grease stains on fabric.

Suitable non-ionic surfactants include alkyl alkoxylates, alkenyl alkoxylates, C6-C22 alcohol condensates with ethylene oxide/propylene oxide block polymers; C14-C22 mid-chain branched alcohols, C14-C22 mid-chain branched alkyl alkoxylate, alkylpolysaccharides, (for example alkylpolyglycosides), methylester ethoxylates, polyhydroxy fatty acid amides, ether capped poly(oxyalkylated) alcohol surfactants, acyl polyethoxylated-glycerol esters (for example cocoyl POE-glycerol esters) and mixtures thereof.

In some embodiments, the non-ionic surfactant may be a condensation product of straight or branched chain fatty alcohols containing between 6 and 24 carbon atoms with between 4 and 30 moles of ethylene oxide having a HLB between 8 and 15.

Preferably the or each non-ionic surfactant comprises an alkoxylated compound. Preferably the alkoxylated non-ionic surfactant comprises at least two alkoxy residues, preferably at least two ethoxy residues.

Suitable alkoxylated non-ionic surfactants include any compound comprising one or more alkylene oxide residue and a hydrophobic group. Preferred non-ionic surfactants are compounds which include one or more ethylene oxide and/or propylene oxide residue and a hydrophobic group. Suitable non-ionic surfactants may be formed by the reaction of aliphatic alcohols, acids or amides with alkylene oxides. Preferably the hydrophobic group comprises a hydrocarbon chain having at least 4 carbon atoms, preferably at least 5 carbon atoms, more preferably at least 6 carbon atoms. Preferably the hydrophobic group comprises from 6 to 30 carbon atoms, more preferably from 6 to 21 carbon atoms, most preferably from 8 to 18 carbon atoms or 12 to 18 carbon atoms. Preferably the hydrophobic group is an alkyl group. The non-ionic surfactant component (b) may include more than one hydrophobic residue.

Preferred non-ionic surfactants for use herein are alkoxylated alcohols prepared from a C8 to C24 alcohol and 2 to 18 molar equivalents of ethylene oxide.

Especially preferred non-ionic surfactants are alkoxylated alcohols are C12-16 or C12-18 alcohols ethoxylated with approximately 7 molar equivalents of ethylene oxide or C10 alcohol ethoxylated with 5 molar equivalents of ethylene oxide.

Such ethoxylated alcohols may also be present in the composition as a residual starting material of the alkyl ether carboxylic acid component used to form the component (a) salt of an alkanolamine and an alkyl ether carboxylic acid.

Component (b) is suitably present in an amount of at least 1 wt %, at least 2 wt % or at least 5 wt % of the detergent composition.

Component (b) is suitably present in an amount of up to 30 wt %, up to 20 wt % or up to 15 wt % of the detergent composition.

Component (b) is suitably present in an amount of from 1 to 30 wt %, from 2 to 20 wt % or from 5 to 15 wt % of the detergent composition.

Suitably the surfactant of component (b) is obtained from a renewable source.

The non-ionic surfactant of component (b) suitably improves the cleaning performance of the detergent composition.

The detergent composition of this first aspect comprises component (c) at least one solvent including at least one hydroxy functional group. Suitable such solvents include monohydric alcohols, polyhydric alcohols and alkoxy alcohols. Preferred solvents are miscible with water.

Suitable simple monohydric alcohols include methanol, ethanol, isopropanol and butanol.

Preferably component (c) comprises a polyhydric alcohol or an alkoxy alcohol.

Suitable alkoxy alcohols include diethylene glycol monobutyl ether, 3-methoxy-3-methyl-1-butanol and 2-butoxyethanol.

One especially preferred alkoxy alcohol for use herein is 3-methoxy-3-methyl-1-butanol.

Suitable polyhydric alcohols include glycerol, ethylene glycol, polyethylene glycol, propylene glycol, dipropylene glycol and polypropylene glycol. Preferred polyhydric alcohols are propylene glycol or a mixture of propylene glycol and glycerol.

In some embodiments, component (c) is propylene glycol. Suitably the propylene glycol is obtained from a renewable source.

Component (c) may comprise propylene glycol, dipropylene glycol, 3-methoxy-3-methyl-1-butanol or a mixture thereof.

In some embodiments, component (c) comprises propylene glycol and dipropylene glycol.

In some embodiments, component (c) comprises propylene glycol and glycerol.

In some embodiments, component (c) comprises 3-methoxy-3-methyl-1-butanol and dipropylene glycol.

In some embodiments, component (c) may comprise a second solvent in addition to the solvent including at least one hydroxy functional group. The second solvent may be a non-water miscible solvent. Suitable such solvents may be selected from one or more of hydrocarbon oils, alkylcarbonates, synthetic and vegetable oils, essential oils, oily esters, silicon oils or perfumes.

Suitably component (c) is present in an amount of at least 5 wt %, at least 10 wt % or at least 15 wt % of the detergent composition.

Suitably component (c) is present in an amount of up to 45 wt %, up to 40 wt % or up to 35 wt % of the detergent composition.

Suitably component (c) is present in an amount of from 5 to 45 wt %, from 10 to 40 wt % or from 15 to 35 wt % of the detergent composition.

The detergent composition of this first aspect may comprise (d) a salt of an amine and a fatty acid. It will be appreciated that the amine and the fatty acid referred to herein as present in the salt of component (d) are in their anionic forms, i.e. with the amine protonated and the fatty acid deprotonated. Such salts of an amine and a fatty acid may be known as alkanolamine soaps.

The amine is preferably a primary amine.

Suitably the amine has 2 to 24 carbon atoms, preferably 2 to 12 carbon atoms, for example 2 to 6 carbon atoms, 2 to 5 carbon atoms or 2 to 4 carbon atoms. Most preferably the amine has 2 carbon atoms.

Preferably the amine is an alkanolamine. The amine may be monoalkanolamine, a dialkanolamine, a trialkanolamine, an N-alkyl alkanolamine or an N-hydroxyalkyl alkanolamine. Suitable N-alkyl alkanolamines are methyl alkanolamines, or a mixture thereof. Suitable N-hydroxyalkyl alkanolamines are N-hydroxymethyl alkanolamines. Preferably the amine is a monoalkanolamine.

The amine of component (d) is suitably a monoalkanolamine or a dialkanolamine. The amine of component (d) is suitably a monoalkanolamine or a dialkanolamine having 2 to 6 carbon atoms. Suitably the amine is selected from monoethanolamine, monopropanolamine, monoisopropanolamine, monobutanolamine and diethanolamine, or a mixture thereof.

Preferably the amine is a monoalkanolamine, suitably having from 2 to 4 carbons. In some embodiments, the alkanolamine is monoethanolamine (MEA).

Component (d) comprises the salt of an amine and a fatty acid. Although reference is made to a fatty acid, it will be understood that this material may comprise a mixture of components. Suitably at least 50% of the fatty acid molecules have at least 12 carbon atoms.

The fatty acid may comprise a mixture of compounds, typically a mixture of isomers and/or homologues.

The skilled person will appreciate that natural sources of fatty acids often contain mixtures.

Suitably the fatty acid comprises compounds of formula RCOOH wherein R is an optionally substituted alkyl or alkenyl group. Preferably R is an unsubstituted alkyl or alkenyl group. In preferred embodiments R is an alkyl group.

Preferred fatty acids are saturated fatty acids.

The fatty acid may comprise some unsaturated components but predominantly saturated compounds are preferred. Suitably at least 50% of the fatty acid molecules are saturated, suitably at least 75% or at least 90%. Preferably all or substantially all of the fatty acid molecules are saturated.

In especially preferred embodiments at least 80%, preferably at least 90% of the fatty acid molecules have 12 to 18 carbon atoms.

Preferably at least 90% of the fatty acid molecules are saturated C12 to C18 fatty acids.

In some embodiments the fatty acid is derived from palm kernel oil or coconut oil and therefore comprises a high proportion of C12 fatty acid chains.

In some embodiments, component (d) is a salt of a monoalkanolamine and a fatty acid wherein at least 80% of the fatty acid molecules have 12 to 18 carbon atoms.

In such embodiments, component (d) is suitably a salt of monoethanolamine and a fatty acid derived from palm kernel oil or coconut oil.

Component (d) may be present in the detergent composition as a foam control agent.

Component (d) is suitably present in an amount of at least 10 wt %, at least 15 wt % or at least 20 wt % of the detergent composition.

Component (d) is suitably present in an amount of up to 50 wt %, up to 40 wt % or up to 30 wt % of the detergent composition.

Component (d) is suitably present in an amount of from 10 to 50 wt %, from 10 to 40 wt % or from 15 to 35 wt % of the detergent composition.

Suitably component (d) is obtained from a renewable source.

The detergent composition of this first aspect may comprise a component (e) at least one further nitrogen-containing surfactant. When present in the detergent composition, component (e) comprises one or more surfactants that are different surfactants to components (a), (b) and (d).

Preferably component (e) comprises one or more nitrogen-containing surfactants selected from alkanolamides, amine oxides and amphoteric or zwitterionic compounds, or mixtures thereof. The nitrogen-containing surfactants of component (e) may provide improved cleaning performance at relatively low temperatures, is suitably mild to skin and eyes and may improve the wetting ability of the detergent composition.

In some embodiments component (e) comprises an alkanolamide.

In some embodiments component (e) comprises an amine oxide.

In some embodiments component (e) comprises an amphoteric or zwitterionic nitrogen-containing surfactant, preferably a betaine.

Preferably component (e) comprises a betaine or an amine oxide.

In some embodiments component (e) comprises a betaine and an alkanolamide.

In some embodiments, component (e) comprises an alkanolamide, an amine oxide and a betaine.

In some embodiments, component (e) comprises a betaine and an amine oxide.

In some embodiments, component (e) comprises an amine oxide and an alkanolamide.

By alkanolamide we mean to refer to the reaction product of an alkanolamine and a fatty acid donor (for example a fatty acid, a fatty acid ester or a triglyceride). The alkanolamide may be referred to as a fatty acid alkanolamide. The reaction product of a fatty acid and alkanolamine suitably mainly contains the fatty acid alkanolamide. The reaction product may contain some ester compound formed by the fatty acid and the alkanolamine. Therefore the reaction product of the fatty acid and the alkanolamine may be a mixture of fatty acid alkanolamide and fatty acid amino ester.

The alkanolamide may be prepared from a monoalkanolamine or a dialkanolamine.

Preferably the alkanolamide is prepared from a monoalkanolamine.

In some embodiments the alkanolamide is prepared from a dialkanolamine.

Preferably the alkanolamide comprises the reaction product of a fatty acid donor and an alkanolamine selected from monoethanolamine, monopropanolamine, monoisopropanolamine monobutanolamine and diethanolamine, or a mixture thereof.

Preferably the alkanolamide comprises the reaction product of a fatty acid donor and monoisopropanolamine. Therefore the alkanolamide is suitably a fatty acid alkanolamide comprising a fatty acid moiety.

Suitably the fatty acid moiety is derived from a fatty acid of formula RCOOH wherein R is an optionally substituted alkyl, hydroxyalkyl, alkenyl or hydroxyalkenyl group, for example hydroxystearic acid group. Preferably R is an unsubstituted alkyl or alkenyl group. In preferred embodiments R is an alkyl group.

Preferably R is an alkyl or alkenyl group having 6 to 36 carbon atoms, preferably 6 to 30 carbon atoms, more preferably 8 to 24 carbon atoms, for example 10 to 20 carbon atoms.

In some preferred embodiments the fatty acid moiety comprises predominantly C12 fatty acids.

The skilled person will appreciate that natural sources of fatty acids typically comprise mixtures of compounds.

Preferably the fatty acid moiety is coconut fatty acid or palm kernel fatty acid. In such embodiments, the alkanolamide may be formed by the reaction of an alkanolamine with free coconut or palm kernel fatty acid or a coconut or palm kernel fatty acid ester, for example a monoester or a triglyceride compound.

Preferably the alkanolamide is formed by the reaction of a coconut fatty acid ester with monoisopropanolamine.

Suitably the alkanolamide has the formula (II):

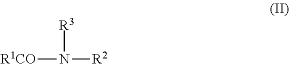

wherein R¹ is an alkyl, alkenyl hydroxyalkyl and hydroxyalkenyl containing 6 to 22 carbon atoms, R² is a hydroxyalkyl group containing 2, 3, 4, 5 or 6 carbon atoms, and R³ is hydrogen or an alkyl group or has the same meaning as R². Preferably, R² is a hydroxyisopropyl group, in which case the molecule can be referred to as an alkanoyl isopropanol amide. Preferably R³ is hydrogen.

Suitable examples of such fatty acid alkanolamides are Cocamide MIPA (i.e. EMPILAN® CIS), Cocamide MEA (i.e. EMPILAN® CME/T), Cocamide DEA (i.e. EMPILAN®2502), Cocamide methyl MEA, Lauramide MEA, Lauramide DEA, Lauramide MIPA, Myristamide MEA, Myristamide DEA, Myristamide MIPA, Stearamide MEA, Stearamide DEA, Stearamide MIPA, Hydroxystearamide MEA, Isostearamide DEA, N-Tris(hydroxymethyl) methyl lauramide, Oleamide MEA, Oleamide DEA; Oleamide MIPA, Soyamide MEA, Soyamide DEA, Soyamide MIPA, Behenamide MEA, Behenamide DEA, Palmitamide MEA, Palmitamide DEA, Ricinoleamide MEA, Ricinoleamide DEA, Ricinoleamide MIPA, Tallowamide MEA, Tallowamide DEA, Undecylenamide MEA, Undecylenamide DEA, N-Lauroyl-N-methylglucamide, N-Cocoyl-N-methylglucamide or a mixture thereof.

In embodiments wherein component (e) comprises an alkanolamide, the alkanolamide is preferably cocamide MIPA.

Preferred amine oxides for use herein are oxides of tertiary amines. Preferably the amine oxide is an oxide of an tertiary alkylamine or alkenylamine having 6 to 36 carbon atoms, preferably 6 to 30 carbon atoms, more preferably 8 to 24 carbon atoms, for example 10 to 20 carbon atoms or 12 to 18 carbon atoms.

Preferably the amine oxide is an oxide of a tertiary alkylamine. The amine oxide may comprise a mixture of compounds, suitably a mixture of homologues. The skilled person will understand that amines obtained from natural sources typically comprise mixtures of compounds.

Preferably the amine oxide comprises a mixture of C12 to C18 amine oxides.

In some embodiments component (e) comprises an amphoteric or zwitterionic nitrogen-containing surfactant.

Amphoteric or zwitterionic nitrogen-containing surfactants for use as component (e) in the compositions of the present invention may include those which have an alkyl or alkenyl group of 7 to 22 carbon atoms and comply with an overall structural formula (III):

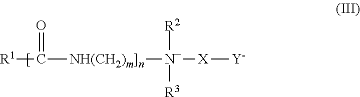

where R¹ is an alkyl or alkenyl group having 7 to 22 carbon atoms; R² and R³ are each independently alkyl, hydroxyalkyl or carboxyalkyl of 1 to 6 carbon atoms; m is 2 to 4; n is 0 or 1; X is alkylene of 1 to 6 carbon atoms optionally substituted with hydroxyl; and Y is —CO₂ or —SO₃.

Such amphoteric or zwitterionic nitrogen-containing surfactants may comprise compounds of the above formula having different numbers of carbon atoms in the R¹ group, within the range of 7 to 22 carbon atoms. For example when the R¹ is derived from a natural source such as a coconut fatty acid derivative.

Nitrogen-containing surfactants suitable for use as component (e) may include simple betaines of formula (IV):

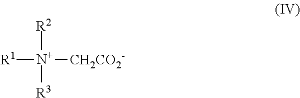

and amido betaines of formula (V):

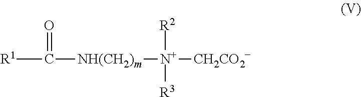

where m is 2 or 3.

In both formulae (IV) and (V), R¹, R² and R³ are as defined previously. R¹ may, in particular, be a mixture of C₁₂ and C₁₄ alkyl groups derived from coconut so that at least half, preferably at least three quarters, of the groups R¹ has 10 to 14 carbon atoms. R² and R³ are preferably methyl.

In some preferred embodiments, R¹ may be a C8 alkyl group so that at least half, preferably at least three quarters, of the groups R¹ has 8 carbon atoms. R² and R³ are preferably methyl.

In some preferred embodiments, R¹ may be a C10 alkyl group so that at least half, preferably at least three quarters, of the groups R¹ has 10 carbon atoms. R² and R³ are preferably methyl.

In some preferred embodiments, R¹ may be a mixture of C8 and C10 alkyl groups so that at least half, preferably at least three quarters, of the groups R¹ has 8 to 10 carbon atoms. R² and R³ are preferably methyl.

Suitable amphoteric or zwitterionic nitrogen-containing surfactants for use as component (e) may include sultaines (or sulphobetaines) of formula (VI) or (VII):

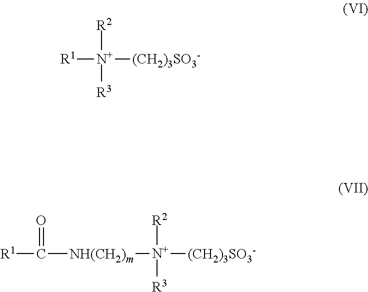

wherein m is 2 or 3, or variants of these in which
—(CH₂)₃SO₃⁻ is replaced by

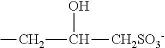

wherein R¹, R² and R³ in these formulae are as defined previously.

Suitable amphoteric or zwitterionic nitrogen-containing surfactants for use as component (e) may include amphoacetates and diamphoacetates. Amphoacetates generally conform to the following formula (VIII):

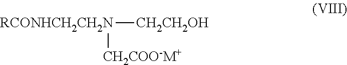

Diamphoacetates generally conform to the following formula (IX):

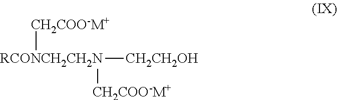

wherein R is an aliphatic group of 7 to 22 carbon atoms and M is a cation such as sodium, potassium, ammonium, or substituted ammonium.

Suitable acetate-based amphoteric surfactants include lauroamphoacetate; alkyl amphoacetate; cocoampho(di)acetate; cocoamphoacetate; disodium cocoamphodiacetate; sodium cocoamphoacetate; disodium cocoamphodiacetate; disodium capryloamphodiacete; disodium lauroamphoacetate; sodium lauroamphoacetate and disodium wheatgerm amphodiacetate.

Suitable betaine surfactants include alkylamido betaine; alkyl betaine, C_{12/14} alkyldimethyl betaine; cocoamidopropylbetaine; tallow bis(hydroxyethyl) betaine; hexadecyldimethylbetaine; cocodimethylbetaine; alkyl amido propyl sulfo betaine; alkyl dimethyl amine betaine; coco amido propyl dimethyl betaine; alkyl amido propyl dimethyl amine betaine; cocamidopropyl betaine; lauryl betaine; laurylamidopropl betaine, coco amido betaine, lauryl amido betaine, alkyl amino betaine; alkyl amido betaine; coco betaine; lauryl betaine; diemethicone propyl PG-betaine; oleyl betaine; N-alkyldimethyl betaine; coco biguamide derivative, C8 amido betaine; C12 amido betaine; lauryl dimethyl betaine; alkylamide propyl betaine; amido betaine; alkyl betaine; cetyl betaine; oleamidopropyl betaine; isostearamidopropyl betaine; lauramidopropyl betaine; 2-alkyl-N-carboxymethyl-N-hydroxyethyl imidazolinium betaine; 2-alkyl-N-carboxyethyl-N-hydroxyethyl imidazolinium betaine; 2-alkyl-N-sodium carboxymethyl-N-carboxymethyl oxyethyl imidazolinium betaine; N-alkyl acid amidopropyl-N,N-dimethyl-N-(3-sulfopropyl)-ammonium-betaine; N-alkyl-N,N-dimethyl-N-(3-sulfopropyl)-ammonium-betaine; cocodimethyl betaine; apricotamidopropyl betaine; isostearamidopropyl betaine; myristamidopropyl betaine; palmitamidopropyl betaine; cocamidopropyl hydroxyl sultaine; undecylenamidopropyl betaine; cocoamidosulfobetaine; alkyl amido betaine; C12/18 alkyl amido propyl dimethyl amine betaine; lauryldimethyl betaine; ricinol amidobetaine; tallow aminobetaine; octyl amidopropyl betaine; decyl amidopropyl betaine; C8 amidopropyl betaine; C10 amidopropyl betaine; C8-C10 amidopropyl betaine and C12-C18 amidopropyl betaine.

Suitable glycinate-based amphoteric surfactants include cocoamphocarboxyglycinate; tallowamphocarboxygycinate; capryloamphocarboxyglycinate, oleoamphocarboxyglycinate, bis-2-hydroxyethyl tallow glycinate; lauryl amphoglycinate; tallow polyamphoglycinate; coco amphoglycinate; oleic polyamphoglycinate; N—C_{10/12} fatty acid amidoethyl-N-(2-hydroxyethyl)-glycinate; N—C_{12/18}-fatty acid amidoethyl-N-(2-hydroxyethyl)-glycinate and dihydroxyethyl tallow glycinate.

Preferred acetate-based amphoteric surfactants for use as component (e) include sodium lauroamphocaetate, disodium lauroamphoacetate and mixtures thereof.

Preferred betaine surfactants for use as component (e) are amido betaines. Especially preferred compounds include cocoamidopropyl betaine and amidopropyl betaines prepared from C8 and/or C10 fatty acids.

Preferably component (e) comprises one or more of: the alkanolamide reaction product of a fatty acid having 8 to 20 carbon atoms and a monoalkanolamine; an amine oxide having 8 to 20 carbon atoms; and an amido betaine prepared from C6 to C20 fatty acids.

Preferably component (e) is selected from an amine oxide having 8 to 24 carbon atoms, an amido betaine prepared from C6 to C20 fatty acids or a mixture thereof.

In some embodiments, component (e) comprises an anionic surfactant. Suitable anionic surfactants may be selected from one or more of acyl isethionates, alkyl acyl isethionates, non-acylated alkyl isethionates; acyl taurates, acyl alkyl taurates, acyl and alkyl glutamates, acyl and alkyl sarcosinates, acyl and alkyl glycinates, acyl and alkyl alaninates and acyl and alkyl aspartates.

In such embodiments, component (e) is suitably selected from one or more acyl taurate, acyl alkyl taurate or acyl glutmate.

In embodiments wherein component (e) comprises an acyl taurate and/or an acyl alkyl taurate, the acyl taurate and/or acyl alkyl taurate is suitably one or more compound of formula (X):

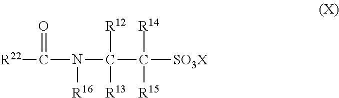

wherein:
X hydrogen, a metal ion or an optionally substituted ammonium ion;
R²² is an optionally substituted C₃-C₃₅ hydrocarbyl group;
each of R¹², R¹³, R¹⁴ and R¹⁵ independently represents hydrogen or an optionally substituted C₁-C₄ alkyl group; and
R¹⁶ is hydrogen or an optionally substituted C₁-C₄ alkyl group.

X may be hydrogen, a metal ion or an optionally substituted ammonium ion. Suitable metal cations include alkali metal cations, for example sodium, lithium and potassium cations, and alkaline earth metal cations, for example calcium and magnesium cations. Suitably, X is an alkali metal cation or an optionally substituted ammonium cation. Preferably, X is a potassium or sodium cation. Most preferably, X is a sodium cation.

R²² is an optionally substituted C₃-C₃₅ hydrocarbyl group. Suitably R²² is an optionally substituted C₅-C₂₉ hydrocarbyl group, suitably an optionally substituted C₇-C₁₇ hydrocarbyl group.

Preferably R²² is an optionally substituted C₃-C₃₅ alkyl or alkenyl group, an optionally substituted C₅-C₂₉ alkyl or alkenyl group or an optionally substituted C₇-C₁₇ alkyl or alkenyl group.

Preferably R²² is a C₃-C₃₅ alkyl or alkenyl group, a C₅-C₂₉ alkyl or alkenyl group or a C₇-C₁₇ alkyl or alkenyl group.

Suitably R²² is an unsubstituted C₃-C₃₅ alkyl or alkenyl group, an unsubstituted C₅-C₂₉ alkyl or alkenyl group or an unsubstituted C₇-C₁₇ alkyl or alkenyl group.

R²² may be provided by a mixture of more than one of said groups.

R²² is preferably an alkyl group or a mixture of alkyl groups with said number of carbons.

Preferably the R²² groups comprise less than 5 wt % alkenyl groups, suitably less than 1 wt % alkenyl groups, suitably substantially no alkenyl groups.

Preferably R²² is an unsubstituted C₇-C₁₇ alkyl group.

R²² is suitably the residue of a fatty acid. Fatty acids obtained from natural oils often include mixtures of fatty acids. For example, the fatty acid obtained from coconut oil contains a mixture of fatty acids including C₁₂ lauric acid, C₁₄ myristic acid, C₁₆ palmitic acid, C₈ caprylic acid, C₁₀ capric acid and C₁₈ stearic and oleic acid. Therefore, R²² may be provided by the residues of a mixture of said fatty acids.

Preferably, R²² is the residue of a hydrogenated fatty acid and therefore R²² contains substantially no alkenyl groups. For example, R²² may be provided by the residues resulting from the hydrogenation of coconut oil. Therefore, R²² may be provided by the residues of a mixture of C₁₂ lauric acid, C₁₄ myristic acid, C₁₆ palmitic acid, C₈ caprylic acid, C₁₀ capric acid and C₁₈ stearic acid. R²² may be a mixture of C₈, C₁₀, C₁₂, C₁₄, C₁₆ and C₁₈ alkyl groups, suitably straight chain alkyl groups, suitably derived from coconut oil. Fatty acids derived from coconut oil comprise at least 85 wt % fatty acids having 12 to 18 carbon atoms. Therefore, R²² suitably comprises at least 85 wt % of C₁₂-C₁₈ alkyl groups. Suitably, in said mixtures, the majority of the R²² groups are C₁₂ alkyl groups. R²² may include the residue of one or more naturally occurring fatty acids and/or of one or more synthetic fatty acids. Suitably R¹ is provided by one or more naturally occurring fatty acids.

In some embodiments R²² may consist essentially of the residue of a single fatty acid.

Examples of fatty acids from which R²² may be derived include coconut acid, hexanoic acid, caproic acid, caprylic acid, capric acid, lauric acid, myristic acid, palmitic acid, palmitoleic acid, stearic acid, oleic acid, linoleic acid, arachidic acid, gadoleic acid, arachidonic acid, eicosapentanoic acid, behenic acid, erucic acid, docosahexanoic lignoceric acid, naturally occurring fatty acids such as those obtained from rice bran oil, oat oil, wheat germ oil, hemp seed oil, coconut oil, tallow, palm kernel oil, butterfat, palm oil, olive oil, corn oil, linseed oil, peanut oil, fish oil and rapeseed oil; synthetic fatty acids made as chains of a single length or a selected distribution of chain lengths; and mixtures thereof.

R²² may be provided by the fatty acids obtained from coconut oil and/or palm kernel oil.

R²² may be provided by lauric acid.

Suitable C₁ to C₄ alkyl groups for R¹², R¹³, R¹⁴, R¹⁵ and R¹⁶ may be selected from n-propyl, ethyl or methyl, such as ethyl or methyl, most preferably methyl.

In some embodiments R¹⁶ is methyl.

In some embodiments, each of R¹², R¹³, R¹⁴ and R¹⁵ is hydrogen and the compound of formula (X) is an acyl N-alkyl taurate surfactant. In such embodiments R¹⁶ is preferably n-propyl, ethyl or methyl.

Preferably R¹⁶ is ethyl or methyl, most preferably methyl. Thus in such embodiments the compound of formula (X) is preferably an acyl N-methyl taurate surfactant.

In some embodiments one of the groups R¹², R¹³, R¹⁴ and R¹⁵ represents an optionally substituted C₁-C₄ alkyl group and the remaining groups represent hydrogen. For example, R¹² may represent an optionally substituted C₁-C₄ alkyl group and R¹³, R¹⁴ and R¹⁵ may all represent hydrogen. For example, R¹⁴ may represent an optionally substituted C₁-C₄ alkyl group and R¹², R¹³ and R¹⁵ may all represent hydrogen.

Preferably R¹² represents a methyl group and R¹³, R¹⁴ and R¹⁵ all represent hydrogen or R¹⁴ represents a methyl group and R¹², R¹³ and R¹⁵ all represent hydrogen.

The acyl alkyl taurate surfactant may include a mixture of more than one taurate compound of formula (X). For example, an isomeric mixture of acyl N-alkyl alkyl taurate compounds may be present. Such a mixture may include, for example an acyl N-alkyl alkyl taurate compound in which R¹² represents a C₁-C₄ alkyl group (suitably methyl) and R¹³, R¹⁴ and R¹⁵ are all hydrogen and an acyl N-alkyl alkyl taurate compound in which R¹⁴ represents a C₁-C₄ alkyl group (suitably methyl) and R¹², R¹³ and R¹⁵ are all hydrogen.

Suitably such mixtures comprise at least 90% of compounds in which R¹² is methyl and R¹⁴ is hydrogen and at most 10% of compounds in which R¹² is hydrogen and R¹⁴ is methyl.

Preferably the acyl alkyl taurate surfactant comprises one or more taurate compounds of formula (X) selected from sodium lauroyl methyl taurate, sodium cocoyl methyl taurate, sodium oleoyl methyl taurate, sodium myristoyl methyl taurate, sodium lauroyl N-methyl methyl taurate, sodium cocoyl N-methyl methyl taurate, sodium oleoyl N-methyl methyl taurate and sodium myristoyl N-methyl methyl taurate. Sodium lauroyl methyl taurate and sodium cocoyl methyl taurate are especially preferred.

In embodiments wherein component (e) comprises an acyl glutmate, the acyl glutmate is suitably one or more a compound of formula (XI):

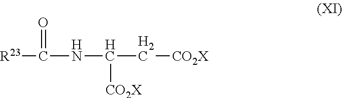

wherein:
each X is hydrogen, a metal ion or an optionally substituted ammonium ion; and
R²³ is an optionally substituted C₃-C₃₅ hydrocarbyl group.

Suitably X is as further defined above in relation to the compound of formula (X).

Suitably R²³ is as defined above in relation to R²² of the compound of formula (X).

R²³ may be provided by the fatty acids obtained from coconut oil and/or palm kernel oil.

Suitably R²³ is provided by lauric acid. Suitably component (e) comprises sodium lauroyl glutamate.

In such embodiments wherein component (e) comprises an anionic surfactant, the anionic surfactant is suitably selected from sodium lauroyl isethionate, sodium cocoyl isethionate, sodium lauroyl methyl isethionate, sodium cocoyl methyl isethionate, sodium lauroyl methyl taurate and sodium cocoyl methyl taurate, sodium lauroyl glutamate, or mixtures thereof.

Suitably component (e) has a percentage renewable carbon index (% RCI) of at least 70%, at least 80%, at least 90% or at least 98%, preferably at least 99%. Preferably component (e) has a % RCI of from 95 to 100%, preferably from 99 to 100%. Preferably component (e) has a % RCI of approximately 100%.

Component (e) is suitably present in an amount of at least 1 wt %, at least 2 wt %, at least 3 wt % or at least 4 wt % of the detergent composition.

Component (e) is suitably present in an amount of up to 15 wt %, up to 10 wt % or up to 8 wt % of the detergent composition.

Component (e) is suitably present in an amount of from 1 to 20 wt %, from 2 to 20 wt %, from 3 to 15 wt %, from 4 to 10 wt % or from 4 to 8 wt % of the detergent composition.

Suitably component (e) is obtained from a renewable source.

The detergent composition of this first aspect may comprise a component (f at least one enzyme. Suitable enzymes for use in detergent compositions, for example laundry detergent compositions, are known in the art. Component (f may be selected from a protease, an amylase, a mannanase or a lipase, or a mixture thereof. The enzyme of component (f) may improve the cleaning performance of the detergent composition, in particular in laundry detergent applications, in particular at relatively low washing temperatures. The inventors have found that the combination of components (a), (b) and (c) with component (f may advantageously provide an unexpected increase in cleaning performance. This may be due to the detergent compositions of the present invention being more compatible with such enzymes than known detergent compositions comprising LAS, for example. This improved compatibility with enzymes and consequent increase in the performance of the enzymes is believed to be due in particular to the use of component (a), the salt of an alkanolamine and an alkyl ether carboxylic acid.

It is believed that protease enzymes are the most adversely affected when combined in a detergent composition with LAS. Therefore the use of protease enzymes in the detergent composition of this first aspect may be particularly advantageous compared to known detergent compositions comprising protease enzymes and LAS. Such detergent compositions may be particularly effective in removing protein-based matter from a substrate.

The or each enzyme of component (f) may be present in the detergent composition in an amount of from 0.05 to 1.00 wt % or from 0.10 to 0.70 wt % of the detergent composition.

The detergent composition of this first aspect suitably has a renewable carbon index (RCI) of at least 30%, at least 40%, at least 50% or at least 60%. Methods for determining the renewable carbon content of the aforementioned components and therefore of such detergent compositions are known in the art.

The detergent composition may comprise some water (g). The detergent composition suitably comprises less than 20 wt % water, suitably less than 15 wt % water, less than 10 wt % water or less than 9 wt % water, based on the total weight of the detergent composition. The detergent composition may comprise at least 0.1 wt % water, at least 0.5 wt % water or at least 1 wt % water.

Suitably the detergent composition comprises from 0.5 to 10 wt % water or from 0.5 to 9 wt % water.

The relatively low amount of water contained in the detergent composition suitably allows the composition to be compatible with a water-soluble film in a sachet or capsule unit dose.

The detergent composition of the present invention may optionally comprise one or more further components.

Suitable further components may include any components commonly used in detergent compositions.

Suitable additional components may include cationic surfactants, corrosion inhibitors, scents, perfume carriers, chelating agents, bleaching agents, bleach activators, biocides, dyes, pigments, fragrances, pH adjusting agents, builders (preferably silicates or zeolites), peroxide based compounds (especially hydrogen peroxide) chlorine bleaches, perborate compounds, bleach activators and catalysts.

When the composition of the first aspect is a dishwashing composition it may include any of these components.

Preferably the composition of the first aspect of the present invention is a laundry detergent composition.

Suitable additional components for inclusion in laundry compositions will be known to the person skilled in the art and include chelating agents, builders, bleaching agents, bleach activators, pigments, dispersants, polymeric dispersing agents, dyes, dye transfer inhibitors, fragrances, fragrance delivery systems, enzyme stabilizers, biocides, probiotics, preservatives, pH adjusting agents, phosphates, silicates, zeolites, peroxide based compounds (especially hydrogen peroxide, chlorine bleaches), perborate compounds, percarbonate compounds, bleach activators and catalysts, cationic surfactants, redeposition additives, brighteners, sud suppressors, fabric softeners and hydrotropes.

In some preferred embodiments the composition of the first aspect comprises an anti-redeposition agent. These compounds help maintain salts in solution during the machine wash cycle.

Suitable anti-redeposition agents will be known to the person skilled in the art. Such components often comprise polyimines. One suitable compound is sold under the trade mark Sokalan HP20 and is an ethoxylated polyethylene polyimine.

Anti-redeposition agents are typically included in an amount of from 0.1 to 2 wt %.

Preferably the composition or the first aspect comprises a chelating agent. Suitable chelating agents will be known to the person skilled in the art.

Suitable chelating agents include ethylenediamine-N,N′-disuccinic acid, methylglycinediacetic acid, glutamic acid N,N-diacetic acid, imino disuccinic acid, diethylene triamine pentaacetic acid, ethylenediamine tetraacetic acid, diethylenetriamine penta methylene phosphonic acid, etidronic acid, citric acid and anions, salts and mixtures thereof.

Preferred chelating agents for use herein are phosphonate chelating agents.

Chelating agents are typically included in an amount of from 0.1 to 2 wt %.

Other preferred components for inclusion in the compositions of the first aspect include probiotics, dye transfer inhibitors and wash performance boosting polymers. Wash performance boosting polymers are known to those skilled in the art. For example, the composition of the first aspect may comprise polyacrylates, polycarboxylates, cellulose derivatives, polyesters based on terephthalic acid, ethylene/propylene glycol-based polymers, poly(vinylpyrrolidone (PVP), poly(vinylpyridine N-oxide) (PVP-NO), poly(vinylpyridine betaine), biodegradable polymeric dispersants (for example polyamino acid polymers such as polyaspartate and polysaccharides such as oxidized starch), poly(vinyl alcohol), polyalkylene glycol and copolymers of alkylene oxide and vinyl acetate, modified ethoxylated urethane or multifunctional polyethylene imine.

Dye transfer inhibitors are also known to those skilled in the art.

The detergent composition of this first aspect is suitably in liquid form. By this we mean that the compositions are liquid at the temperatures encountered during normal storage and/or prior to use of the compositions, for example ambient temperature or room temperature (for example between 15° C. and 25° C., or between 18° C. and 22° C.). Preferably the compositions are liquid at temperatures above 0° C. The liquid detergent composition preferably has a melting point of at least 0° C.

The detergent composition of this first aspect may be suitable for any one or more of the following uses: toilet care, manual dishwashing, laundry, fabric care, kitchen care, carpet cleaning, vehicle care, polishing products, machine cleaning and maintenance, pesticides, insecticides, fungicides, herbicides, oilfield chemical applications, marine applications, personal care and institutional/industrial cleaning.

Preferably the compositions of the present invention are sufficiently non-irritating and non-toxic that they can be directly handled by the user.

Suitably the detergent composition is readily dissolvable and/or dispersible in water.

Suitably the detergent composition of this first aspect is a liquid laundry detergent composition.

The detergent composition of this first aspect is suitably provided in unit dose form.

In some embodiments, the present invention provides a liquid laundry composition in unit dose form.

The compositions of the present invention are highly effective detergents and have a low water content. They therefore comprise high levels of active ingredients. This allows small unit doses to be provided.

Preferably each unit dose has a mass of from 5 to 100 g, preferably from 5 to 75 g, more preferably from 10 to 50 g, suitably from 15 to 40 g, preferably from 20 to 30 g.

The unit dose of the detergent composition is suitably provided in a water-soluble film sachet, which dissolves in use on exposure to water to release the detergent composition from the sachet. Suitable water-soluble film sachets are known in the art and may be formed from polyvinyl alcohol.

In such embodiments, the detergent composition suitably comprises less than 10 wt % water or less than 9 wt % water, in order for the composition to be compatible with a such water-soluble films in a sachet or capsule unit dose.

In some embodiments the present invention provides a unit dose detergent product comprising a portion of a detergent composition according to the first aspect and a wrapper.

Suitably the portion of the detergent composition is an amount suitable for washing a standard load of laundry.

The portion of the detergent composition may be in solid or liquid form, preferably in liquid form.

The portion of the detergent composition is suitably surrounded by the wrapper. Suitably the detergent composition is sealed with by the wrapper.

The wrapper is suitably made from a thin flexible film.

In some embodiments the wrapper may comprise a water soluble film (e.g. of polyvinyl alcohol) intended to be dosed in a washing machine.

In some embodiments the wrapper may comprise a protective polymeric film which is to be removed before dosing into a washing machine. Such films are suitably frangible and made from material which protects the enclosed detergent composition from moisture and air.

In some embodiments the unit dose detergent product may comprise a water soluble wrapper and a protective polymeric film wrapper.

According to a second aspect of the present invention, there is provided a packaged detergent product comprising a container and a detergent composition according to the first aspect.

Preferred features of the second aspect are as defined in relation to the first aspect.

Suitably the packaged detergent composition comprises a plurality of unit doses of the detergent composition according to the first aspect. In some embodiments the unit doses are provided in water-soluble film sachets, as discussed above. For example, suitable water-soluble film sachets may be formed from polyvinyl alcohol.

In such embodiments, the detergent composition suitably comprises less than 10 wt % water or less than 9 wt % water, in order for the composition to be compatible with a such water-soluble films in a sachet or capsule unit dose.

In some embodiments each of the unit dose forms may comprise a protective polymeric film wrapper.

According to a third aspect of the present invention, there is provided a method of laundering items, the method comprising the steps of loading the items into a washing machine, adding a detergent composition into the washing machine, and running a wash cycle of the washing machine, wherein the detergent composition comprises:
(a) at least one salt of an alkanolamine and an alkyl ether carboxylic acid;
(b) at least one surfactant; and
(c) at least one solvent including at least one hydroxy functional group.

The detergent composition used in the method of this third aspect may have any of the suitable features and advantages discussed in relation to the first aspect.

According to a fourth aspect of the present invention, there is provided a use of a detergent composition in toilet care, manual dishwashing, laundry, fabric care, kitchen care, carpet cleaning, vehicle care, polishing products, machine cleaning and maintenance, pesticides, insecticides, fungicides, herbicides, oilfield chemical applications, marine applications, personal care or institutional/industrial cleaning; the detergent composition comprising:
(a) at least one salt of an alkanolamine and an alkyl ether carboxylic acid;
(b) at least one surfactant; and
(c) at least one solvent including at least one hydroxy functional group.

The detergent composition used in the method of this fourth aspect may have any of the suitable features and advantages discussed in relation to the first aspect.

Preferably the use of this fourth aspect is in laundry.

Suitably the use of this fourth aspect provides improved cleaning performance, suitably in laundry applications, suitably without the use of LAS surfactants.

In some embodiments, the detergent composition comprises component (f at least one enzyme and the use of this fourth aspect provides an improvement in the cleaning performance of the at least one enzyme, suitably compared to a similar detergent composition comprising an LAS surfactant.

According to a fifth aspect of the present invention, there is provided a use of a salt of an alkanolamine and an alkyl ether carboxylic acid to improve the cleaning performance of a detergent composition comprising at least one enzyme.

The salt of an alkanolamine and an alkyl ether carboxylic acid may have any of the suitable features and advantages described above in relation to component (a) of the detergent composition of the first aspect. The at least one enzyme of the detergent composition may have any of the suitable features and advantages of component (f as described above in relation to the first aspect. Suitably the detergent composition of the use of this fifth aspect is a detergent composition according to the first aspect, comprising component (f.

Suitably the improvement in the cleaning performance of the detergent composition comprising at least one enzyme is compared to a similar detergent composition comprising an LAS surfactant and not comprising the salt of an alkanolamine and an alkyl ether carboxylic acid as described herein. Suitably the salt of an alkanolamine and an alkyl ether carboxylic acid is used to replace such LAS surfactants in said detergent composition.

Suitably the improvement in the cleaning performance of the detergent composition comprising at least one enzyme is in removing protein-based matter from a substrate, suitably a fabric.

In some embodiments, the improvement in the cleaning performance of the detergent composition is the maintenance of cleaning performance of the detergent composition overtime, for example on storage of the detergent composition. Suitably said cleaning performance of the detergent composition is maintained after at least one week, at least two weeks or at least one month of storage of the detergent composition, suitably at a temperature of above 0° C. and suitably less than 50° C. Cleaning performance tends to decline significantly over time in similar detergent compositions which comprise LAS surfactants. Suitably said cleaning performance is maintained to a greater extent than in a similar detergent composition comprising an LAS surfactant and not comprising the salt of an alkanolamine and an alkyl ether carboxylic acid as described herein.

Suitably the detergent composition of the present invention loses no more than 20% of its cleaning performance after storage at 40° C. for one month, suitably no more than 10% of its cleaning performance, suitably as measured by the method of Laundry Performance Evaluation Test 2 described below. Similar detergent compositions comprising an LAS surfactant may lose 30% or greater of their cleaning performance after storage at 40° C. for one month, in such tests.

Said maintenance of cleaning performance over time may be provided by an improvement in the stability of the at least one enzyme, wherein the activity/effectiveness of the at least one enzyme is substantially maintained over said periods of time. Said activity/effectiveness of such enzymes tends to decline significantly over time in similar detergent compositions which comprise LAS surfactants.

Therefore the present invention may provide the use of a salt of an alkanolamine and an alkyl ether carboxylic acid as defined herein for maintaining the activity of at least one enzyme in a detergent composition. Preferably the detergent composition is substantially free of alkylbenzenesulfonates (such as LAS surfactants). Suitably said activity of said enzyme is substantially maintained after at least one week, at least two weeks or at least one month of storage of the detergent composition, suitably at a temperature of above 0° C. and suitably less than 50° C. Suitably said activity of the at least one enzyme is maintained to a greater extent than in a similar detergent composition comprising an LAS surfactant and not comprising the salt of an alkanolamine and an alkyl ether carboxylic acid as described herein.

### EXAMPLES

### Preparation of Examples 1, 2, 1e and 2e

The following examples of the present invention and comparative examples were prepared by the procedures below using the components listed in Table 1 in the amounts shown. The amounts listed in the table refer to the amount of active ingredient ignoring any impurities or by-products. Examples 1e and 2e have the same composition as Examples 1 and 2, respectively, except that the listed enzyme components are included and a corresponding amount of propylene glycol removed. Example 1 and 1e were prepared by charging propylene glycol to a 1 litre jacketed reaction vessel fitted with an overhead stirrer. The temperature was set between 20-25° C. and monoethanolamine (MEA) was added. Distilled, topped palm kernel fatty acid was gradually added ensuring that the batch temperature did not exceed 30° C. After stabilising the temperature between 20-25° C., a blend of C12-18 amine oxide, alcohol ethoxylate (C12-C18*7EO) and propylene glycol was added, followed by the preformed MEA salt of laureth-5-carboxylic acid (see below). Enzymes (when present) were added followed by a phosphonate (Dequest 2066), anti-redeposition polymer (Sokolan HP20), colourant (optional) and perfume (optional). The formulation was stirred at 20-25° C. until homogenous then discharged from the reaction vessel.

Dequest 2066 is a product of Italmatch (Genova, Italy).

Sokolan HP20 is a product of BASF (Ludwigshafen, Germany).

Examples 2 and 2e were prepared by an analogous procedure by replacing the C12-18 amine oxide with cocamidopropyl betaine (CAPB), in the amount noted in Table 1.

Comparative Examples 1 and 1e were by an analogous procedure by omitting the C12-18 amine and replacing the MEA salt of laureth-5-carboxylic acid with the LAS surfactant MEA dodecylbenzene sulfonate, in the amount noted in Table 1.

Preparation of MEA Salt of laureth-5-carboxylic Acid

The MEA salt of laureth-5-carboxylic acid was prepared from Empicol CED5 which is a commercially available mixture comprising laureth-5 carboxylic acid (ca 75.5 wt %), laureth-5 (unreacted raw material), NaCl (reaction by-product) and water. MEA was added to the Empicol CED5 until the mixture reached neutral pH to provide the MEA salt of laureth-5-carboxylic acid containing approximately 76 wt % active material.

The formulations Examples 3-10 were prepared by a similar procedure to that described above for Examples 1, 2, 1e and 2e. In Examples 3-10, the salt of the alkanolamine and the alkyl ether carboxylic acid was formed in situ from the alkanolamine (MIPA or MEA) and the alkyl ether carboxylic acid (laureth-5-carboxylic acid or laureth-11-carboxylic acid) by adding both components to the formulation in the amounts stated in Table 1b below.

RCI values of the different components and the overall detergent compositions are also provided in Table 1, showing that the Examples of the present invention have an increased RCI compared to the Comparative Examples comprising LAS surfactant. This higher RCI signifies that the compositions of the present invention can be more environmentally sustainable than LAS containing detergent compositions.

TABLE 1a

| Ingredients (as 100% active) | RCI % | Ex. 1 | Ex. 2 | Ex. 1e | Ex. 2e | Comp Ex. 1 | Comp Ex. 1e |
|---|---|---|---|---|---|---|---|
| C12-18 Amine oxide | 88 | 5.92 | | 6 | | | |
| C12-18 + 7 EO | 49 | 8.03 | 8.78 | 8.4 | 8.75 | 8.75 | 8.75 |
| Propylene Glycol veggie | 100 | 31.16 | 25.8 | 29.76 | 24.39 | | |
| Propylene Glycol | | | | | | 39.9 | 38.85 |
| CAPB | 66 | | 5.83 | | 5.83 | | |
| Sodium Chloride | 0 | | 1 | | 1 | | |
| Laureth-5 Carboxylic Acid, MEA salt | 54 | 25 | 25 | 25 | 25 | | |
| MEA dodecylbenzene sulfonate (MEALAS) | | | | | | 19 | 19 |
| MEA-Soap (MMW: 281) | 79 | 25 | 25 | 25 | 25 | 25.35 | 25.35 |
| Protease | | | | 0.4 | 0.4 | | 0.4 |
| Amylas | | | | 0.3 | 0.3 | | 0.3 |
| Mannanase | | | | 0.2 | 0.2 | | 0.2 |
| Lipase | | | | 0.15 | 0.15 | | 0.15 |
| Phosphonate | | 0.25 | 0.25 | 0.25 | 0.25 | 0.25 | 0.25 |
| Polyimine | | 0.4 | 0.4 | 0.4 | 0.4 | 0.4 | 0.4 |
| Water | | <5 | <8 | <5 | <9 | 5.8 | 6.1 |
| Others | | to 100 | to 100 | to 100 | to 100 | to 100 | to 100 |
| RCI % (whole formulation) | | 73.55 | 67.2 | 72.4 | 65.77 | 26 | 26 |
| RCI % (surfactants) | | 66.28 | 64 | 66.2 | 64 | 45.78 | 45.78 |
| RCI % (surfactants + solvents) | | 77 | 73.51 | 77.2 | 73.9 | 24 | 24 |
| Appearance at 25° C. | | clear liquid | clear liquid | clear liquid | clear liquid | clear liquid | clear liquid |

The ingredients in Table 1a above are present as 100 wt % active material unless stated otherwise in Table 2

TABLE 1b

| Ingredients (as 100% active | | Formulations | | | | | | | |
|---|---|---|---|---|---|---|---|---|---|
| unless otherwise stated in Table 2) | RCI % | Ex. 3 | Ex. 4 | Ex. 5 | Ex. 6 | Ex. 7 | Ex. 8 | Ex. 9 | Ex. 10 |
| C12-16 Amine oxide | 86 | 6 | 6 | 6 | 6 | 6 | 6 | | |
| Sodium lauroyl glutamate | 100 | | | | | | | 4.2 | |
| Sodium methyl cocoyl taurate, low salt | 85 | | | | | | | | 5.7 |
| C12-18 Amine oxide | 88 | | | | | | | | |
| C10 + 5 EO | 50 | 8 | 8 | 8 | 8 | 8 | 8 | 8 | 8 |
| C12-18 + 7 EO | 49 | | | | | | | | |
| Propylene Glycol veggie | 100 | | | | | | | | |
| Propylene Glycol | 0 | 8 | 8 | 20.25 | 20.25 | 20.25 | 20.25 | 20.25 | 20.25 |
| 2-phenoxyethanol | 0 | 12.25 | | | | | | | |
| 2-methyl-2,4-penthanediol | 0 | | 12.25 | | | | | | |
| Glycerol | 100 | 12.25 | 12.25 | 12.25 | 12.25 | 12.25 | 12.25 | 12.25 | 12.25 |
| CAPB | 66 | | | | | | | | |
| Sodium Chloride | 0 | | | | | | | 1 | |
| Laureth-5 Carboxylic Acid, MEA salt* | 54 | | | | | | | | |
| Laureth-11 Carboxylic Acid | 37 | 19.55 | 19.55 | 19.55 | | 18.82 | | 19.55 | 19.55 |
| Laureth-5 Carboxylic acid | 54 | | | | 18.99 | — | 19.57 | | |
| MIPA (Monoisopropanolamine) | 0 | | | | 4.35 | 3.14 | | | |
| MEA (Monoethanolamine) | 0 | 2.27 | 2.27 | 2.27 | | | 3.73 | 2.27 | 2.27 |
| MEA dodecylbenzene sulfonate (MEALAS) | 0 | | | | | | | | |
| MEA-Soap (MMW: 281) | 79 | 25 | 25 | 25 | 25 | 25 | 25 | 25 | 25 |
| Protease (as is) | | | | | | | | | |
| Amylase (as is) | | | | | | | | | |
| Mannanase (as is) | | | | | | | | | |
| Lipase (as is) | | | | | | | | | |
| Phosphonate | 0 | 0.25 | 0.25 | 0.25 | 0.25 | 0.25 | 0.25 | 0.25 | 0.25 |
| Polyimine (as is) | 0 | 0.4 | 0.4 | 0.4 | 0.4 | 0.4 | 0.4 | 0.4 | 0.4 |
| EDDS | — | | | | | | | 0.15 | 0.15 |
| Water | | <5 | <5 | ca 7 | ca 7 | ca 7 | ca 7 | <5 | <5 |
| Anti-redeposition polymer, chelating agents etc | 0 | | | | | | | | |
| Others | | to 100 | to 100 | to 100 | to 100 | to 100 | to 100 | to 100 | to 100 |
| Appearance at 25° C. | | clear | clear | clear | clear | clear | clear | clear | clear |
| | | liquid | liquid | liquid | liquid | liquid | liquid | liquid | liquid |
| RCI % (whole formulation) | | 48.39 | 48.39 | 48.39 | 51.41 | 48.12 | 48.39 | 51.38 | 51.25 |

*RCI referred to the acidic form

The abbreviations used in Table 1a and Table 1b are defined below in Table 2.

TABLE 2

| Component | Chemical Names and Sources |
|---|---|
| C12-16 amine oxide | C12-16 amine oxide where the C12-16 C-chain is derived from palm |
| | kernel oil |
| C12-18 amine oxide | C12-18 amine oxide where the C12-18 C-chain is derived from palm |
| | kernel oil |
| C10 + 5 EO | C10 fatty alcohol (synthetic or derived from palm kernel oil) ethoxylated |
| | with 5 mole equivalents of ethylene oxide |
| C12-18 + 7 EO | C12-18 fatty alcohol (derived from palm kernel oil) ethoxylated with 7 |
| | mole equivalents of ethylene oxide |
| CAPB | cocamidopropyl betaine where the C12-18 C-chain is derived from palm |
| | kernel oil |
| laureth-5 carboxylic | Carboxymethylated C12-16 fatty alcohol ethoxylate where the C12-16 C- |
| acid, MEA salt | chain is derived from palm kernel oil (provided as composition comprising |
| | 76 wt % active material) |
| laureth-5 carboxylic | Carboxymethylated C12-16 fatty alcohol ethoxylate where the C12-16 C- |
| acid | chain is derived from palm kernel oil (commercially available as a liquid |
| | comprising 92 wt % active material) |
| laureth-11 carboxylic | Carboxymethylated C12-16 fatty alcohol ethoxylate where the C12-16 C- |
| acid | chain is derived from palm kernel oil (commercially available as a liquid |
| | comprising 86 wt % active material) |
| Sodium lauroyl | Sodium lauroyl glutamate (available as a powder comprising ca 65 wt % |
| glutamate | active material) |
| Sodium methyl cocoyl | Sodium methyl cocoyl taurate, desalinated version (available as a |
| taurate, low salt | powder comprising ca 95 wt % active material) |
| MEA-soap (MMW: 281) | C12-18 fatty acid MEA soap where the fatty acid is derived from palm |
| | kernel oil |
| phosphonate | diethylenetriamine penta (methylenephosphonic acid), sodium salt - |
| | DTPMP |
| EDDS | Ethylenediamine-N,N′-disuccinic acid, 3 sodium salt (available as a liquid |
| | comprising ca 37 wt % active material) |
| polyimine | ethoxylated polyethylene polyimine |

### Laundry Performance Evaluation Test 1

The laundry washing performance of Examples 1, 1e, 2 and 2e and of Comparative Examples 1 and 1e was assessed using a Linitest procedure as described below on a panel of different stain types.

This Linitest procedure evaluates the ability of detergent formulations to remove applied soils from fabrics. Soiled fabric swatches are washed in a laboratory washer (Linitest, SDL Atlas) under specific conditions of temperature, detergent solution, washing time and water hardness. The Linitest machine rotates closed cannisters (8×500 mL) in a thermostatically controlled water bath at 40±2 RPM.

The washing conditions for the washing tests were as shown in Table 3

TABLE 3

| Conditions | |
|---|---|
| Liquid Laundry Detergent Dosage (g/L) | 1.66 |
| Wash Time (min) | 30 |
| Temperature (° C.) | 40 |
| Water Hardness (ppm CaCO₃) | 300 |

For each run, four of the same type of swatches were placed in each closed cannister within the Linitest washer. The swatches were each 6 cm×6 cm in size and simulate different types of fabrics and soil stains. Further details on the stain types of the different swatches and their product codes are given in Table 4. The swatches are commercially available from CFT Center for Test Materials (Vlaardingen, Netherlands).

After the washing cycle, the washes liquors were emptied and the swatches rinsed under running cold tap water, then dried on a clothes line within a fume hood (in the dark and with the fume hood air flow switched on).

The effectiveness of the test detergent against a given type of swatch (e.g. specific fabric and stain type) was assessed by reflectometry. A Datacolor 400 high performance, reflectance only bench top spectrophotometer was used. The spectrophotometer had a D65 light source and a UV cut-off filter (400 nm). Reflectance measurements were taken by the spectrophotometer using the Y-value of the Y, x, y colour coordinates measurement (according to AISE protocol standard for laundry washing tests).

Measurements were taken of the soiled swatch before the wash and of the cleaned swatch after the wash. The measurements were taken with each swatch in a defined set of different positions and an average value used to generate the results. The results discussed herein were generated by averaging the measurements (before and after the wash) for the four swatches used in each test. The following formula was used to calculate detergency as the percentage change in reflectance, compared to the initial reflectance before the washing cycle.

$$Detergency = \frac{100 \times ( {R}_{2} - {R}_{1} )}{{R}_{1}}$$

Where:
R1=reflectance of soiled cloth before wash
R2=reflectance of soiled cloth after wash

A positive value for the above detergency calculation means that the swatch material has become more reflective after washing. This signifies that the stain has been removed or partially removed from the swatch by the detergent composition during the test. In some cases where the detergent composition has been ineffective in washing the swatch, a negative detergency value may be produced due to an apparent decrease in reflectivity of the swatch compared to before the test. This is thought to be due to re-deposition of soil/stain on the swatch during the test which may actually further reduce the reflectivity of the swatch.

TABLE 4

| Swatches | Fabric | Soil |
|---|---|---|
| E-101 | Cotton | Carbon black/Olive oil |
| E-104 | Poly/Cotton | Carbon black/Olive oil |
| E-106 | Cotton | IEC Carbon Black/Mineral Oil |
| E-118 | Cotton | Sebum/Pigment |
| E-119 | Poly/Cotton | Sebum/Pigment |
| E-143 | Cotton | Make-up 7g/m2 |
| W10-Z | Cotton | Chocolate |
| C-S-06 | Cotton | Salad dressing with natural black |
| C-S-37 | Cotton | Full egg with carbon black |
| C-S-38 | Cotton | Aged Full egg with carbon black |
| C-05 | Cotton | Blood/Ink/ Milk |
| PC-05 | Poly/Cotton | Blood/Ink/ Milk |
| PC-S-37 | Poly/Cotton | Full egg with carbon black |
| PC-S-38 | Poly/Cotton | Aged Full egg with carbon black |

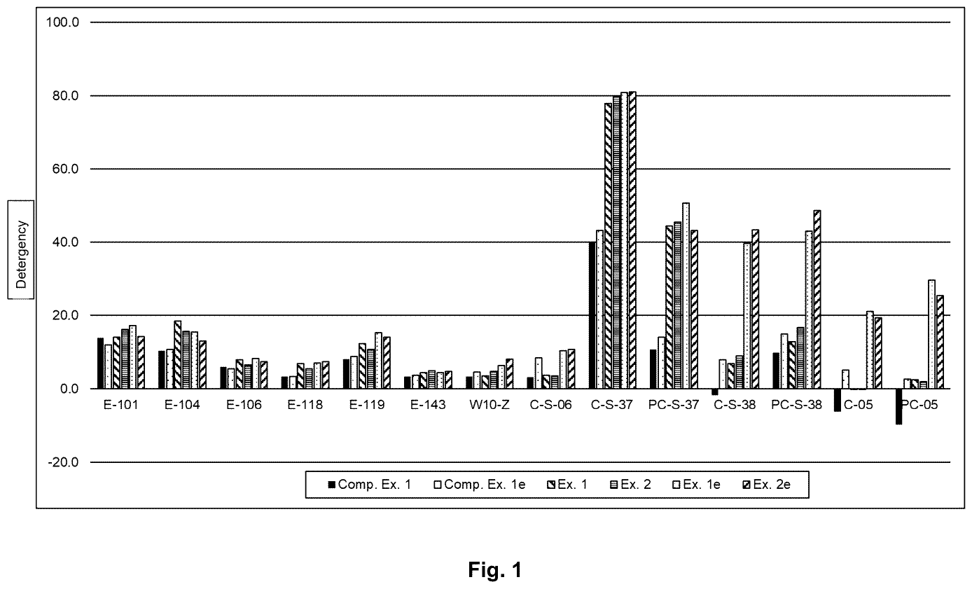

The results of these tests for each swatch/stain type are given for the Examples and Comparative Examples in the bar chart of FIG. 1. FIG. 1 shows good washing performance (as measured by the detergency measurements and calculation discussed above) for the Examples 1, 2, 1e and 2e of the present invention across a range of stains. For some of these stains, swatches E-101 to C-S-06, the washing performance of the Examples 1, 2, 1e and 2e was comparable to or better than the Comparative Examples 1 and 1e containing LAS surfactant, demonstrating that the present invention can provide detergent compositions have good washing performance which can be produced from more sustainable sources. The results for swatches C-S-37 and PC-S-37 show that the washing performance of Examples 1, 2, 1e and 2e was significantly better than the Comparative Examples 1 and 1e containing LAS surfactant. Therefore for at least these particular stains, the compositions of the present invention may provide superior washing performance compared to similar compositions comprising LAS surfactants. The results for swatches C-S-38 to PC-05 show that the enzyme-containing Examples 1e and 2e provided significantly improved washing performance compared to the Comparative Examples (eg the LAS based formulation—both with and without the enzymes). The results show that the addition of enzymes to the Comparative Example detergent compositions (i.e. comparing Comp. Ex. 1 with Comp. Ex. 1e) provides little or no improvement in washing performance against these stains. The improved results obtained with the enzyme-containing Examples 1e and 2e suggest that the cleaning activity of the enzymes is retained in the compositions of the present invention to a much greater extent than the LAS-containing detergent compositions, providing a significant performance advantage to said compositions.

Laundry Performance Evaluation Test 2—Performance after Ageing

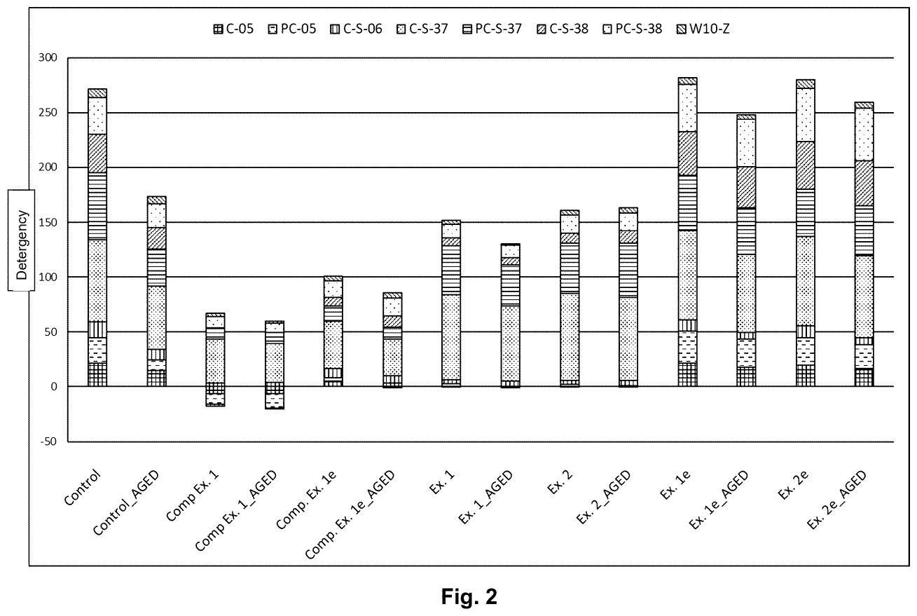

In order to test the stability of the example formulations in maintaining laundry performance over time, Examples 1, 2, 1e and 2e, Comparative Examples 1 and 1 e, and a control sample (see Table 5) were aged under controlled conditions and then subjected to the same laundry washing performance testing as described above (Laundry Performance Evaluation Test 1), against unaged samples of each example and the control formulation. The aged samples were obtained by storing the formulations at 40° C. for one month. The aged samples are denoted “AGED” in the results shown in FIG. 2.

TABLE 5

| Ingredients | Wt % active |
|---|---|
| C12-18 + 7 EO | 20-40 |
| Propylene Glycol | present |
| MEA dodecylbenzene sulfonate (MEALAS) | 20-40 |
| MEA-Soap (MMW: 281) | present |
| Enzymes cocktail | Present |
| Water | Ca 6 |
| Ethanol | 1-5 |
| Glycerol | Present |
| Anti-redeposition polymer, chelating agents etc | Present |
| Others | To 100 |

These laundry performance tests were carried using the following fabric swatches described above and in Table 4: W10-Z, C-S-06, C-S-37, C-S-38, C-05, PC-05, PC-S-37 and PC-S-38. The results of the laundry performance tests before and after ageing are shown in FIG. 2. In FIG. 2, the results with the different swatches are collated into a single bar for each example (unaged and aged), to show overall performance.

The results shown in FIG. 2 demonstrate that the reduction in performance on ageing is significantly lower for Examples 1, 2, 1e and 2e than for the control formulation containing alkylbenzenesulfonate surfactants. Therefore the formulations of Examples 1, 2, 1e and 2e of the present invention appear to provide the advantage of maintaining cleaning performance on ageing to a greater extent than similar formulations comprising alkylbenzenesulfonates.

In particular, the results for Examples 1e and 2e for the swatches C-05 and PC-05 comprising stains which require enzymatic action for effective cleaning, show only a small reduction in cleaning performance on ageing whilst a much more significant reduction in performance was observed for the control formulation on ageing. Therefore these results show that the formulations of the present invention may advantageously maintain enzyme activity during ageing compared to formulations containing alkylbenzenesulfonates which suffer significant reductions in performance on ageing, particularly on stains requiring enzymes for effective cleaning.

### Film Stability

Stability tests were performed using formulations Examples 1, 1e, 2 and 2e, all packed in polyvinyl alcohol (PVA) film. The packaged laundry liquid detergent samples were stored at 40° C. No deterioration of the packaging was observable after 3 months indicating that the formulations have excellent compatibility with PVA film.

These results demonstrate that the combination of components of the detergent composition of the present invention provides good and in some cases improved washing performance compared to a known laundry composition comprising LAS, in particular in tackling protein-based stains. This performance is suitably obtained whilst allowing a high RCI % to be achieved and therefore reducing the environmental impact of such detergent compositions. Furthermore, the detergent compositions of the present invention may be used in water-soluble film sachets and remain stable during storage.

Although a few preferred embodiments have been shown and described, it will be appreciated by those skilled in the art that various changes and modifications might be made without departing from the scope of the invention, as defined in the appended claims.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention. Typically, when referring to compositions, a composition consisting essentially of a set of components will comprise less than 5% by weight, typically less than 3% by weight, more typically less than 1% by weight of non-specified components.

The term “consisting of” or “consists of” means including the components specified but excluding addition of other components.

Whenever appropriate, depending upon the context, the use of the term “comprises” or “comprising” may also be taken to encompass or include the meaning “consists essentially of” or “consisting essentially of”, and may also be taken to include the meaning “consists of” or “consisting of”.

For the avoidance of doubt, wherein amounts of components in a composition are described in wt %, this means the weight percentage of the specified component in relation to the whole composition referred to.

The optional features set out herein may be used either individually or in combination with each other where appropriate and particularly in the combinations as set out in the accompanying claims. The optional features for each aspect or exemplary embodiment of the invention as set out herein are also to be read as applicable to any other aspect or exemplary embodiments of the invention, where appropriate. In other words, the skilled person reading this specification should consider the optional features for each exemplary embodiment of the invention as interchangeable and combinable between different exemplary embodiments.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, and drawings), and/or all of the steps of any method or process so disclosed, may be combined in any combination, except combinations where at least some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, and drawings), or to any novel one, or any novel combination, of the steps of any method or process so disclosed.

1. A detergent composition comprising:
(a) at least one salt of an alkanolamine and an alkyl ether carboxylic acid;
(b) at least one surfactant; and
(c) at least one solvent including at least one hydroxy functional group.

2. The detergent composition according to claim 1, wherein the alkyl ether carboxylic acid of component (a) has the formula (I): 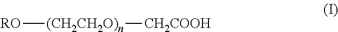
wherein R is a C8 to C24 optionally substituted alkyl or alkenyl group; and
n is an average value from 3 to 18.

3. The detergent composition according to claim 1, wherein the alkanolamine of component (a) is a monoalkanolamine or a dialkanolamine having 2 to 6 carbon atoms.

4. The detergent composition according to claim 1, wherein component (a) is present in an amount of from 10 to 50 wt % of the detergent composition.

5. The detergent composition according to claim 1, wherein the composition comprises less than 5 wt % of linear alkylbenzenesulfonates.

6. The detergent composition according to claim 1, wherein component (b) is a non-ionic surfactant.

7. The detergent composition according to claim 1, wherein component (b) is present in an amount of from 2 to 20 wt % of the detergent composition.

8. The detergent composition according to claim 1, wherein component (c) is present in an amount of from 5 to 45 wt % of the detergent composition.

9. The detergent composition according to claim 1, comprising (d) a salt of an amine and a fatty acid.

10. The detergent composition according to claim 9, wherein component (d) is present in an amount of from 10 to 40 wt % of the detergent composition.

11. The detergent composition according to claim 1, comprising (e) at least one nitrogen-containing surfactant.

12. The detergent composition according to claim 11, wherein component (e) is present in an amount of from 1 to 20 wt % of the detergent composition.

13. The detergent composition according to claim 1, comprising (f) at least one enzyme.

14. The detergent composition according to claim 13, wherein component (f) is selected from a protease, an amylase, a mannanase, a lipase, or a mixture thereof.

15. The detergent composition according to claim 1, having a renewable carbon index of at least 40%.

16. The detergent composition according to claim 1, comprising less than 10 wt % water.

17. The detergent composition according to claim 1, wherein the detergent composition is in liquid form.

18. The detergent composition according to claim 1, which is provided in unit dose form.

19. A packaged detergent product comprising a container and a detergent composition according to claim 1.

20. A method of laundering items, the method comprising the steps of loading the items into a washing machine, adding a detergent composition into the washing machine, and running a wash cycle of the washing machine, wherein the detergent composition comprises:
(a) at least one salt of an alkanolamine and an alkyl ether carboxylic acid;
(b) at least one surfactant; and
(c) at least one solvent including at least one hydroxy functional group.

21. Use of a detergent composition in toilet care, manual dishwashing, laundry, fabric care, kitchen care, carpet cleaning, air fresheners, vehicle care, polishing products, machine cleaning and maintenance, pesticides, insecticides, fungicides, herbicides, oilfield chemical applications, marine applications, personal care or institutional/industrial cleaning;
the detergent composition comprising:
(a) at least one salt of an alkanolamine and an alkyl ether carboxylic acid;
(b) at least one surfactant; and
(c) at least one solvent including at least one hydroxy functional group.

22. Use of a salt of an alkanolamine and an alkyl ether carboxylic acid to improve the cleaning performance of a detergent composition comprising at least one enzyme.
